(19) United States
(12) Patent Application Publication
(10) Pub. No.: US 2019/0145104 A1
(43) Pub. Date: May 16, 2019

(54) SKYLIGHT SYSTEM

(71) Applicant: MONTLEIGH PTY LTD, CHELTENHAM (AU)

(72) Inventor: SURESH SUTRAVE, CHELTENHAM (AU)

(73) Assignee: MONTLEIGH PTY LTD, CHELTENHAM (AU)

(21) Appl. No.: 16/310,495

(22) PCT Filed: Jun. 16, 2017
(86) PCT No.: PCT/AU2017/000131

§ 371 Date: Dec. 17, 2018

(30) Foreign Application Priority Data
Jun. 17, 2016 (AU) 2016902357

(51) Int. Cl. E04D 13/03; E06B 3/54

(52) U.S. Cl. CPC E04D 13/0315; E06B 3/5481; E04D 13/031

(57) ABSTRACT

A system of components for forming a skylight which includes a base frame formed from lengths of identical base frame extrusions a glazing frame formed from lengths of identical glazing frame extrusions angular corner pieces for joining the base frame extrusions and the glazing frame extrusions to form a base frame and a glazing frame respectively a glazing panel adapted to be adhered at its edges to said glazing frame and said glazing panel being adapted to be attached to said base frame. The set of component extrusions reduces the cost of making custom measured skylights. Preferably Aluminium extruded frame members are used. The glass sheet is adhered at its edges to the upper edge of a glazing support frame. The glazing support frame extrusions preferably include a protective edge that extends up from the support surface to enclose the edge of the glass sheet.

### BACKGROUND TO THE Invention

Prefabricated skylights are known.

U.S. Pat. No. 6,223,481 discloses a sky light construction using aluminium extrusions.

GB patent 2204627 discloses the use of extrusions to grip the edges of the glass.

U.S. Pat. No. 9,045,905 discloses a skylight having an apex patch.

Most commercial skylights are made in predetermined sizes and are not customised to the end user's needs.

The assembly methods are not adapted to meeting the needs of users who desire customised dimensions.

It is an object of this invention to provide a system that is adapted to fabrication to the dimensions specified by the end users.

### BRIEF DESCRIPTION OF THE INVENTION

To this end the present invention provides a system of components for forming a skylight which includes

a base frame formed from lengths of identical base frame extrusions

a glazing frame formed from lengths of identical glazing frame extrusions

angular corner pieces for joining the base frame extrusions and the glazing frame extrusions to form a base frame and a glazing frame respectively

a glazing panel adapted to be adhered at its edges to said glazing frame

and said glazing panel being adapted to be attached to said base frame.

The method and set of component extrusions of this invention reduces the cost of making custom measured skylights. Preferably Aluminium extruded frame members are used. The glass sheet is adhered at its edges to the upper edge of a glazing support frame. The glazing support frame extrusions preferably include a protective edge that extends up from the support surface to enclose the edge of the glass sheet. The corners, formed when the glazing extrusions are arranged into the glazing support frame, are secured using corner pieces. The same corner pieces may be used in assembling the base frame which is fitted into the opening in the roof. The glazing and base frame extrusions preferably include recesses for hinge pieces so that the assembled glazing frame may be pivotally attached to the base frame along one edge. The adhesives used are selected for weather resistance and may also be selected for a fire rating. The extrusions may also be adapted for filling with insulation or fire retardants.

The extruded frame members can easily be cut to custom lengths and then formed into a frame using the common corner joining pieces. This enables custom made skylights to be made economically.

### DETAILED DESCRIPTION OF THE INVENTION

A preferred embodiment of the invention will now be described with reference to the drawings in which

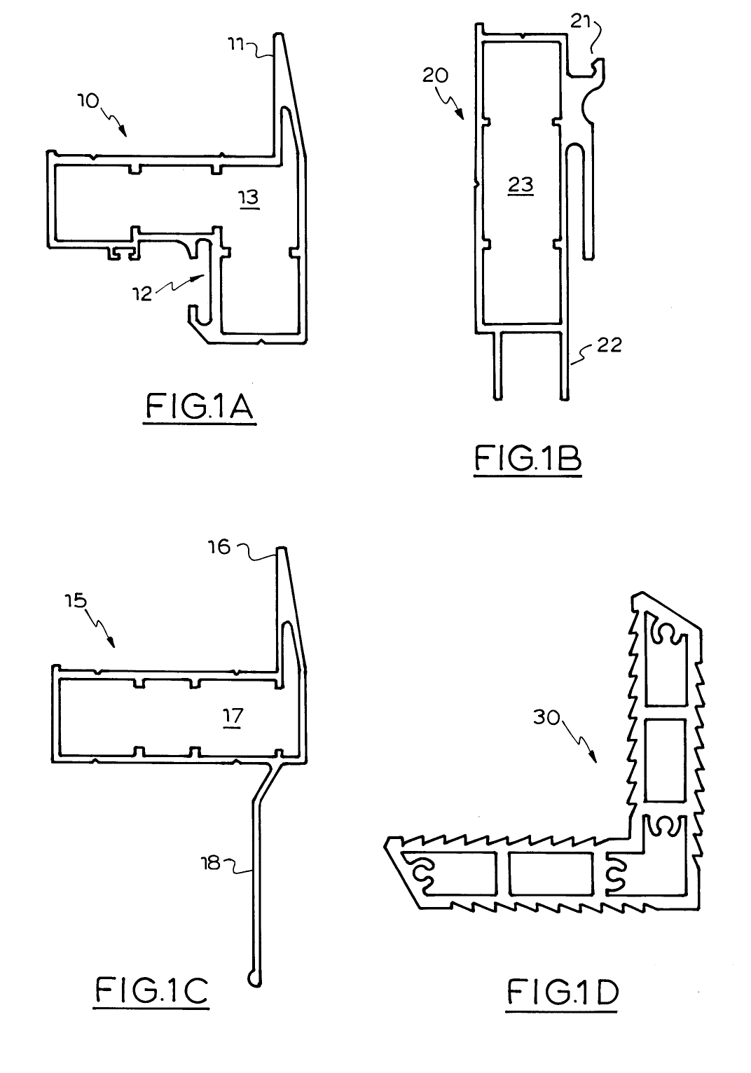

FIGS. 1A to 1H illustrate the components of the invention;

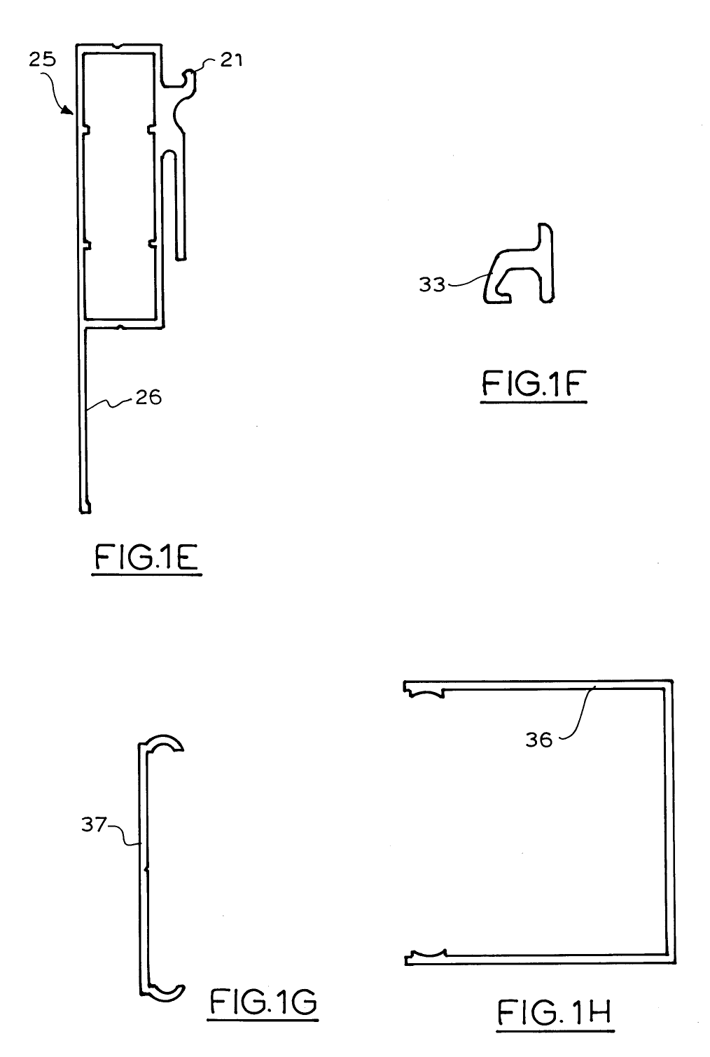

FIG. 2 illustrates an isometric view and an exploded view of the skylight of this invention;

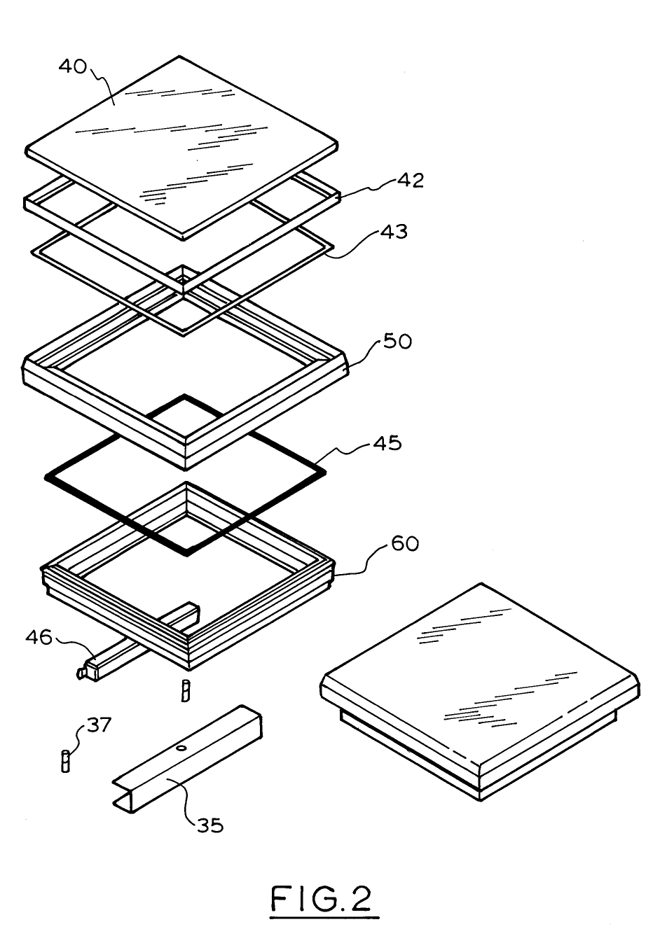

FIG. 3 is a cross sectional view of an assembled skylight;

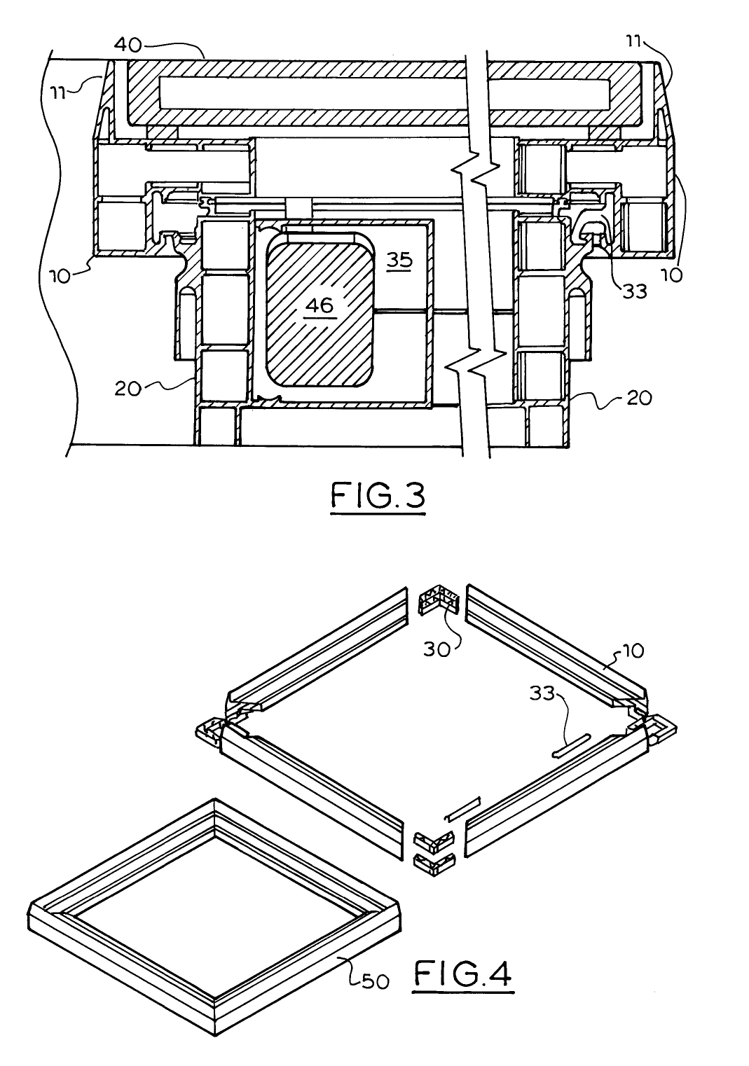

FIG. 4 is an isometric and exploded view of a glazing frame; and

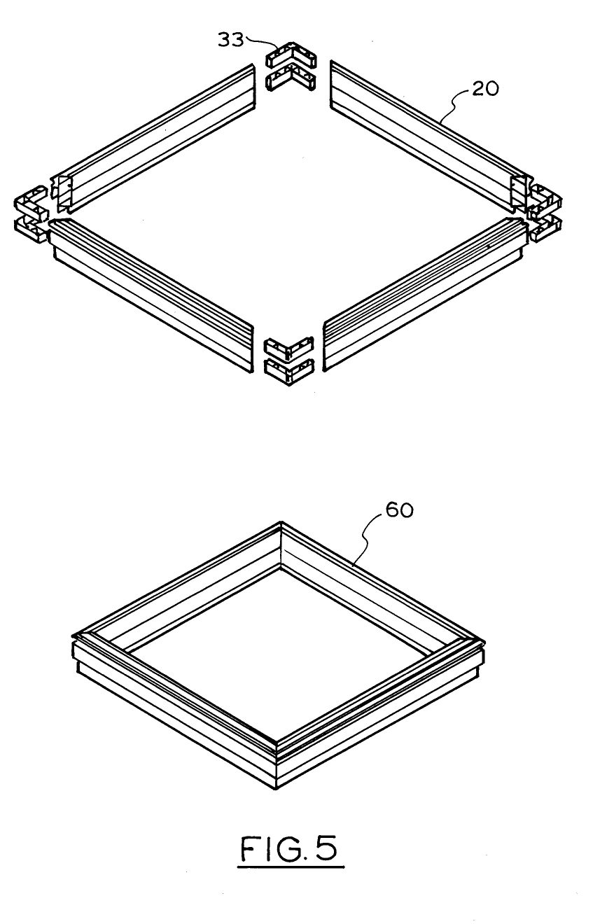

FIG. 5 is an isometric and exploded view of a base frame.

The core components of the invention are the extruded aluminium glazing frame extrusions 10 and base frame extrusions 20. As shown in FIGS. 1A and 4 the extruded frames 10 can be cut to the desired lengths and assembled into a frame 50 using the corner pieces 33 shown in FIG. 1 D. The glazing extrusion 10 is designed to support the glazing sheet 40 and the edges of the sheet 40 are protected by the projections 11. FIG. 1 C illustrates the extrusion 15 used for an alternate glazing frame.

The glass sheet may be double glazed, it is adhered and sealed to the glazing frame 60 using a silicon sealant 42 and adhesive tape 43 as shown in FIG. 2.

As shown in FIGS. 1B and 5 the extruded base frames 20 can be cut to the desired lengths and assembled into a frame 60 using the corner pieces 33 as shown in FIG. 1D. The base frame 60 is designed to support the glazing frame 50 using the custom seal 45 as shown in FIG. 2. The glazing frame can pivot about an edge of the base frame 60 using the hinge extrusions 33 shown in FIG. 1F and FIGS. 4 and 5. The hinge 33 hooks into the hook 12 of the glazing extrusion 10 and the hook 21 of the base extrusion 20 as shown in FIG. 3. An alternate base extrusion 25 is shown in FIG. 1E.

The glazing frame can be pivoted to 90 degrees using the motor 46 which is held in position by the cover 35 (FIG. 1 H) which is attached to the bracket 37 (FIG. 1G) and shown in FIG. 2.

Where fire rating standards are to be met, the sealants and adhesive are selected to meet the required standard. Fire retardants may be injected into the cavities of the extrusions. The glazing may also be selected to meet fire rating standards.

From the above it can be seen that the components of this invention form a system that can be used to make custom dimensioned sky lights that have a fully exposed glass to provide an improved aesthetic appearance. Those skilled in the art will also realise that this invention may be implemented in embodiments other than those is described without departing from the core teachings of this invention.

1. A system of components for forming a skylight which includes:
a base frame formed from lengths of identical base frame extrusions;
a glazing frame formed from lengths of identical glazing frame extrusions;
angular corner pieces for joining the base frame extrusions and the glazing frame extrusions to form a base frame and a glazing frame respectively;
a glazing panel adapted to be adhered at its edges to said glazing frame; and
said glazing panel being adapted to be attached to said base frame.

2. A system as claimed in claim 1 which includes a hinge to fit between the base frame and the glazing frame so that the skylight is openable.

3. A system as claimed in claim 2 in which the glazing and base frame extrusions include recesses for hinge pieces so that the assembled glazing frame may be pivotally attached to the base frame along one edge.

4. A system as claimed in claim 1 in which the extrusions are adapted for filing with insulation or fire retardants.

5. A system as claimed in claim 1 in which the glazing support frame extrusions include a protective edge that extends up from the support surface to enclose the edge of the glazing panel.

6. A skylight assembled from the base frame and glazing frame components defined in claim 1 cut to customised lengths and then formed into a frame using the angular corner joining pieces and fitted with the glazing panel.
